(19) United States
(12) Patent Application Publication
(10) Pub. No.: US 2007/0028232 A1
(43) Pub. Date: Feb. 1, 2007

(54) IMAGE FORMING APPARATUS DRIVER HAVING AUTHORITY OF PRINTING, METHOD OF INSTALLING THE SAME, AND METHOD AND APPARATUS TO PRINT DOCUMENT USING THE SAME

(76) Inventors: Jeong-sang KIM, Suwon-si (KR); Na-young KIM, Suwon-si (KR)

Correspondence Address: STANZIONE & KIM, LLP, 919 18TH STREET, N.W., SUITE 440, WASHINGTON, DC, 20006, US

(21) Appl. No.: 11/460,059

(22) Filed: Jul. 26, 2006

(30) Foreign Application Priority Data
Jul. 27, 2005 (KR) 2005-68616

(51) Int. Cl. G06F 9/445

(52) U.S. Cl. 717/174; 717/120

(57) ABSTRACT

An image forming apparatus driver having a printing authority, a method of installing the same, and a method and apparatus to print a document using the same includes an account information reading unit to read account information of a currently logged-in user, and a printing data generating unit to generate printing data according to a preset printing authority for an account lower than an administrator account with reference to the read account information. The method for installing the same includes reading account information of a currently logged-in user when the image forming apparatus driver is installed, and if the read account information is the administrator account, setting the printing authority for the account lower than the administrator account.

### CROSS-REFERENCE TO RELATED APPLICATIONS

This application claims the priority of Korean Patent Application No. 10-2005-0068616, filed on Jul. 27, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus driver having authority of printing, a method of installing the image forming apparatus driver, and a method and apparatus to print a document using the image forming apparatus driver.

2. Description of the Related Art

Using a computer with a plurality of user accounts is ubiquitous in Windows 2000 or higher operating systems. Usually, an administrator having an administrator account controls other users having lower accounts, such as power user accounts and user accounts. However, non-administrative users are given permission for accessing general folders and printing even though they are not given write permission for special folders such as system folders.

Therefore, if account assignments of a computer are changed, a printer driver is not controlled according to each of the changed user accounts. Accordingly, when the administrator having the administrator account installs the printer driver to the computer and creates a document, other users having default user accounts can use the printer driver installed by the administrator even when the computer is rebooted and when the users log on to the computer using their own accounts. Thus, other users as well as the administrator can print the document created by the administrator.

That is, the user installs the printer driver using the administrator account and creates the document using the administrator account. Then, the user reboots the computer using the user account and can print the document using the printer driver installed using the administrator account.

FIG. 1 is a block diagram illustrating conventional document printing configurations using an administrator account and a user account. When an administrator having the administrator account stores a secure document in a local drive to which a printer driver is installed, a user having a default user account can reboot a computer with his own account and print a secure document using the printer driver. Further, in operating systems such as Windows 2000, printing can be controlled through an Internet web browser when it is preset by the administrator. Therefore, there is a need for secure printing at a printer driver level.

### SUMMARY OF THE INVENTION

The present general inventive concept provides an image forming apparatus driver having authority of printing, the image forming apparatus driver to generate printing data according to a grade of a currently logged-in account.

The present general inventive concept also provides a method of installing an image forming apparatus driver having an authority of printing.

The present general inventive concept further provides a method and apparatus to print a document using an image forming apparatus driver having a printing authority, the image forming apparatus driver to increase a security level to print a document according to the printing authority of a currently logged-in user account.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus driver having a printing authority, the image forming apparatus driver including an account information reading unit to read account information of a currently logged-in user, and a printing data generating unit to generate printing data according to a preset printing authority for an account lower than an administrator account with reference to the read account information.

The foregoing and/or other aspects and utilities of the present general inventive concept may also be achieved by providing a method of installing an image forming apparatus driver having a printing authority, the method including reading account information of a currently logged-in user when the image forming apparatus driver is installed, and if the read account information is an administrator account, setting a printing authority for an account lower than the administrator account. The setting of the printing authority may further include restricting the installing of the image forming apparatus driver if the read account information is not the administrator account.

The foregoing and/or other aspects and utilities of the present general inventive concept may also be achieved by providing a method of printing a document using an image forming apparatus driver having a printing authority, the method including reading account information of a currently logged-in user when the document is open and a print menu is selected, determining whether the read account information is an administrator account, and if the read information is not the administrator account, performing printing in a restricted range according to a printing authority for the account lower than the administrator account. The printing authority for the lower account may include restricting a function of the image forming apparatus driver. The printing authority for the lower account may include restricting image processing of the image forming apparatus driver. The printing authority for the lower account may include restricting printing with a specific application program of the image forming apparatus driver.

The foregoing and/or other aspects and utilities of the present general inventive concept may also be achieved by providing an apparatus to print a document using an image forming apparatus driver having a printing authority, the apparatus including an account information reading unit to read account information of a currently logged-in user, an account determining unit to determine whether the read account information is an administrator account, and a data printing unit to print in a restricted range according to the printing authority for an account lower than the administrator account if the read account information is not the administrator account.

The foregoing and/or other aspects and utilities of the present general inventive concept may also be achieved by providing a computer-readable recording medium having a computer-readable program to perform a method, the method including reading account information of a currently logged-in user when the image forming apparatus driver is installed, and if the read account information is an administrator account, setting the printing authority for an account lower than an administrator account.

The foregoing and/or other aspects and utilities of the present general inventive concept may also be achieved by providing a computer-readable recording medium having a computer-readable program to perform a method, the method including reading account information of a currently logged-in user when the document is open and a print menu is selected, determining whether the read account information is an administrator account, and if the read account information is not the administrator account, performing printing in a restricted range according to the printing authority for an account lower than the administrator account.

The foregoing and/or other aspects and utilities of the present general inventive concept may also be achieved by providing a computer system, including a computer system usable with an image forming apparatus, including a computer unit having an authority level of one of an administrator level, a power user level, and a user level, the computer having an image forming apparatus driver to generate print data depending on the authority level.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating conventional document printing configurations using an administrator account and a user account;

FIG. 2 is a block diagram illustrating an image forming apparatus driver having an authority of printing according to an embodiment of the present general inventive concept;

FIG. 3 is a flowchart illustrating a method of installing a printer driver according to an embodiment of the present general inventive concept;

FIG. 4 is a block diagram illustrating an apparatus to print a document using a printer driver having a printing authority according to an embodiment of the present general inventive concept; and

FIG. 5 is a flowchart illustrating a method of printing a document using a printer driver having a printing authority according to an embodiment of the present general inventive concept.

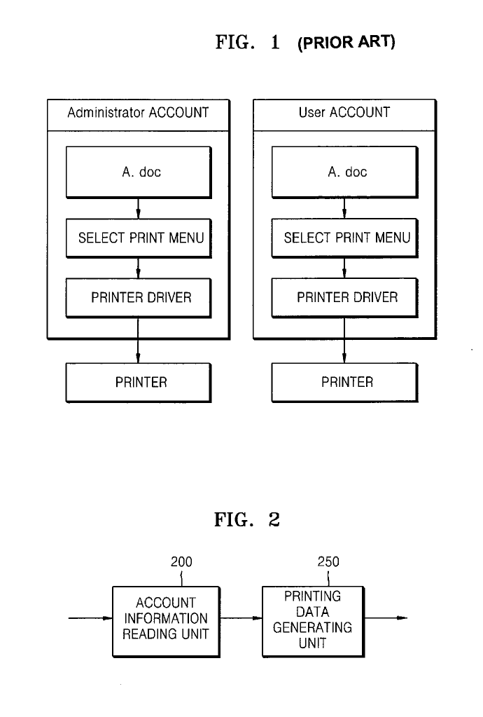

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

In the present general inventive concept, an image forming apparatus may be a printer, a multi-function product, a scanner, a copying machine, or the like. The printer may be a typical example of the image forming apparatus. Therefore, the present general inventive concept will now be described using the printer as an example of the image forming apparatus.

FIG. 2 is a block diagram illustrating an exemplary structure of a printer driver of an image forming apparatus driver having a printing authority according to an embodiment of the present general inventive concept. A printer driver will be described as an example of the image forming apparatus driver. The printer driver may be installed in a computer or the image forming apparatus to generate print data to be printed. When the printer driver may be installed in the computer connected to the image forming apparatus, the printing data is generated from the printer driver and transmitted to the image forming apparatus to print the data. Referring to FIG. 2, the printer driver includes an account information reading unit 200 and a printing data generating unit 250.

The account information reading unit 200 reads account information of a user currently logged into a computer. The printing data generating unit 250 generates printing data according to a preset printing authority for accounts lower than an administrator account such as power user accounts and user accounts with reference to the read account information. The power user account can typically perform almost any task on the computer, printer, or a server, except those reserved for the administrator account. The user account can perform common tasks, but may not be able to affect files outside of the user account. The printing authority for the lower accounts may include a restriction on the use of a specific function of the printer driver, a restriction on image processing of the printer driver, or a restriction on printing with a specific application program of the printer driver. The printing authority can be embodied in modules, such as a function restriction unit to restrict a specific function of the printer driver, a processing restriction unit to restrict image processing of the printer driver, or an application restriction unit to restrict printing with a specific application program of the printer driver.

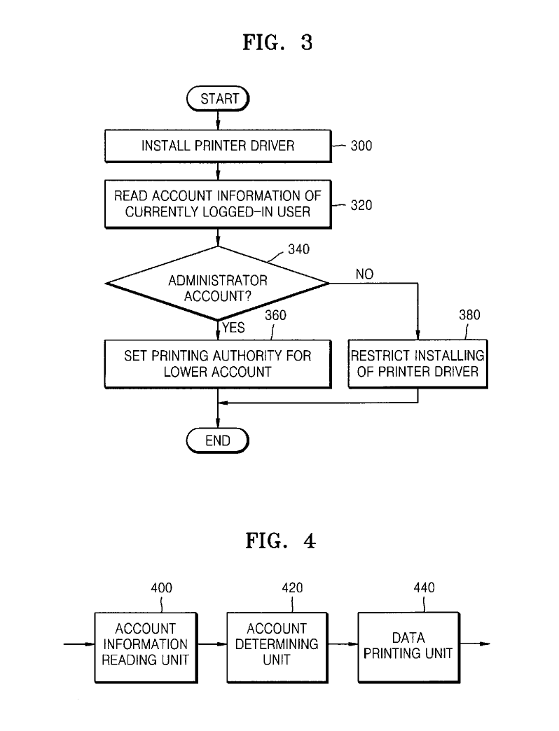

FIG. 3 is a flowchart illustrating a method of installing a printer driver according to an embodiment of the present general inventive concept. Referring to FIG. 3, in operation 300, a printer driver is installed. In operation 320, account information of a currently logged in user is read. In operation 340, it is determined whether the read account information is an administrator account or not. If so, the printing authority for the lower accounts, then the administrative account, is set in operation 360. The printing authority for the lower accounts may include the restriction on the use of a specific function of the printer driver, the restriction on image processing of the printer driver, or the restriction on printing with the specific application program of the printer driver. Meanwhile, when the read account is not the administrator account and, for example, if the read account is a default user account, the installing of the printer driver is restricted in operation 380.

FIG. 4 is a block diagram illustrating a structure of an apparatus to print a document using the printer driver having the printing authority according to an embodiment of the present general inventive concept. Referring to FIG. 4, the apparatus includes an account information reading unit 400, an account determining unit 420, and a data printing unit 440. The account information reading unit 400 reads account information of the currently logged in user. The account determining unit 420 determines whether the read account information corresponds to the administrator account or not. If the read account is not the administrator account, the data printing unit 440 prints in a restricted range according to the printing authority set for the lower account. If the read account information is the administrator account, the data printing unit 440 can print in a range according to the printing authority set for the administrator account. The range according to the administrator account printing authority may be unrestricted.

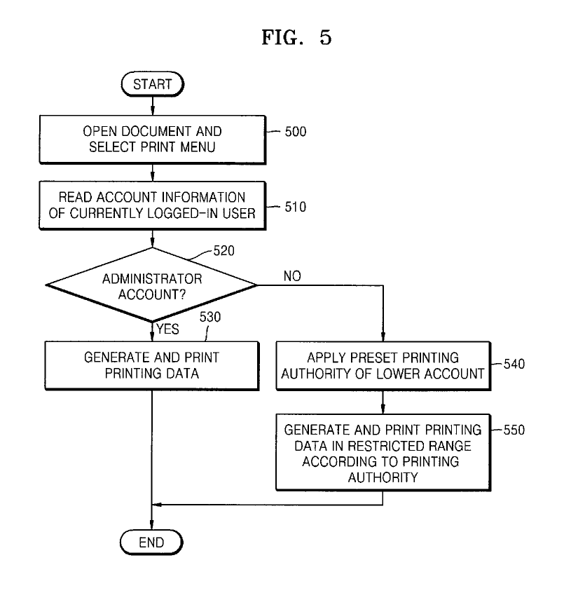

FIG. 5 is a flowchart illustrating a method of printing a document using a printer driver having a printing authority according to an embodiment of the present general inventive concept. Referring to FIG. 5, in operation 500, the document is opened and a print menu is selected. In operation 510, account information of the currently logged in user is read. In operation 520, it is determined whether the read account information is the administrator account or not. If the read account is the administrator account, printing data are generated in operation 530. If not, a preset printing authority for the lower account than the administrator account is applied in operation 540, and the printing data are generated and printed in the restricted range according to the preset printing authority in operation 550.

The printing authority for the lower accounts may include the restriction on the use of the specific function of the printer driver, the restriction on image processing of the printer driver, or the restriction to print with the specific application program of the printer driver. For example, if the currently logged-in user has the user account, and the printing authority granted to the user account restricts image processing of the printer driver, the image data is not printed but only text information is printed.

The general inventive concept above described method can also be embodied as computer-readable codes on a computer-readable recording medium. The computer is any device having a data processing function. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices.

As described above, the image forming apparatus driver includes a printing authority, the method for installing the image forming apparatus driver, and the method and apparatus to print a document using the image forming apparatus driver of the present general inventive concept, the printing authority for lower accounts can be variously provided when the printer driver is installed using an administrator account, so that a security level can be increased and a high-quality security can be provided for printing.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus driver having a printing authority, comprising:
an account information reading unit to read account information of a currently logged-in user; and
a printing data generating unit to generate printing data according to a preset printing authority for an account lower than an administrator account with reference to the read account information.

2. The image forming apparatus driver of claim 1, further comprising:
a unit to generate data to be printed, wherein the printing authority for the lower account restricts a function of the unit.

3. The image forming apparatus driver of claim 1, further comprising:
a unit to generate data to be printed, wherein the printing authority for the lower account restricts image processing of the unit.

4. The image forming apparatus driver of claim 1, further comprising:
a unit to generate data to be printed, wherein the printing authority for the lower account restricts printing with a specific application program of the unit.

5. A method of installing an image forming apparatus driver having a printing authority, the method comprising:
reading account information of a currently logged-in user when the image forming apparatus driver is installed; and
if the read account information is an administrator account, setting a printing authority for an account lower than the administrator account.

6. The method of claim 5, wherein the setting of the printing authority for the lower account comprises restricting a specific function of the image forming apparatus driver.

7. The method of claim 5, wherein the setting of the printing authority for the lower account comprises restricting image processing of the image forming apparatus driver.

8. The method of claim 5, wherein the setting of the printing authority for the lower account comprises restricting printing with a specific application program of the image forming apparatus driver.

9. The method of claim 5, further comprising:
restricting installing of the image forming apparatus driver if the read account information is not the administrator account.

10. A method for printing a document using an image forming apparatus driver having a printing authority, the method comprising:
reading account information of a currently logged-in user when the document is open and a print menu is selected;
determining whether the read account information is an administrator account; and
if the read account information is not the administrator account, performing printing in a restricted range according to a printing authority for an account lower than the administrator account.

11. The method of claim 10, wherein the printing authority for the lower account comprises restricting a specific function of the image forming apparatus driver.

12. The method of claim 10, wherein the printing authority for the lower account comprises restricting image processing of the image forming apparatus driver.

13. The method of claim 10, wherein the printing authority for the lower account comprises restricting printing with a specific application program of the image forming apparatus driver.

14. An apparatus to print a document using an image forming apparatus driver having a printing authority, the apparatus comprising:
an account information reading unit to read account information of a currently logged-in user;
an account determining unit to determine whether the read account information is an administrator account; and
a data printing unit to print in a restricted range according to the printing authority for an account lower than the administrator account if the read account information is not the administrator account.

15. A computer-readable recording medium having a computer-readable program to perform a method, the method comprising:
reading account information of a currently logged-in user when the image forming apparatus driver is installed; and
if the read account information is an administrator account, setting the printing authority for an account lower than an administrator account.

16. A computer-readable recording medium having a computer-readable program to perform a method, the method comprising:
reading account information of a currently logged-in user when the document is open and a print menu is selected;
determining whether the read account information is an administrator account; and
if the read account information is not the administrator account, performing printing in a restricted range according to the printing authority for an account lower than the administrator account.

17. A computer system usable with an image forming apparatus, comprising:
a computer unit having an authority level of one of an administrator level, a power user level, and a user level, the computer having an image forming apparatus driver to generate print data depending on the authority level.

18. The computer system of claim 17, wherein the image forming apparatus driver further comprises:
an account information reading unit to read account information to determine the authority level; and
modules to restrict a printing operation depending on the authority level thereof.

19. The computer system of claim 17, further comprising:
an image forming apparatus connected to the computer to print the print data according to the authority level.

20. The computer system of claim 18, wherein the computer unit sets the authority level to a restricted level to control the image forming apparatus driver with the set restricted level when the authority level is not the administrator level.

21. The computer system of claim 20, wherein the restricted level comprises a preset authorizing level.

22. The computer system of claim 17, wherein the computer unit determines the authority level of the image forming apparatus driver when the computer unit is turned on and accessed according to one of the administrator level, a power user level, and a user level.
